(19) United States
(12) Patent Application Publication
(10) Pub. No.: US 2008/0004965 A1
(43) Pub. Date: Jan. 3, 2008

(54) COIN-FREE RETAIL MANAGEMENT SYSTEM AND METHOD

(76) Inventor: Byungsun PARK, Irvine, CA (US)

Correspondence Address: IPLA P.A., 3580 WILSHIRE BLVD., 17TH FLOOR, LOS ANGELES, CA, 90010, US

(21) Appl. No.: 11/424,216

(22) Filed: Jun. 14, 2006

(51) Int. Cl. G06Q 20/00

(52) U.S. Cl. 705/21

(57) ABSTRACT

Disclosed is a coin-free retail business management system and method. The method comprises reading a customer identification into a business management system, retrieving a first value previously saved under the customer identification; comparing the first value to a second value from a present transaction amount, the second value being a non-billable fraction from the present transaction amount, that is less than the face value of a lowest-valued monetary bill; generating a third value that is an addition of the first and second values; and subtracting the addition less a non-billable fraction of the addition from the present transaction amount.

### BACKGROUND OF THE INVENTION

The invention pertains to a no-coin-involved business management system and method. More particularly, the present invention relates to a coin-free retail business management system and method that allows a coin-free transaction and a coin saving benefit to the customers of small businesses while reserving advantages for both the customers and the small businesses.

A variety of credit based transactions have been prevalent in almost all the cities and countries. Debit cards and membership cards also actively share the role of decreasing cash transactions. Although non-cash transactions have ever been increasing since introduction of credit cards, a majority of small businesses still frequent banks to break bills to coins so as to keep sufficient coins in their cash registers. This should be one of the main reasons why most retail store chains maintain non-free coin collecting machines.

Limitation of conventional coin machines is burdensome fees charged for cashing the coins. Further, those who want to cash a bundle of coins need to travel to such big stores as chain supermarkets which can afford to maintain costly coin machines and which do not usually accommodate products that can be paid by a bunch of coins.

Korean Patent Publication No. 10-2003-0063003 by Cho discloses a conventional approach introduces another card, though not a credit card, to save change from transaction. Specifically, Cho's system and method for managing coin is to enable a consumer to accumulating the change from member shop transactions in a card for cashing and transaction payment in the future. One of the limitations of Cho's system and method seems to be cards that are involved in the system and method.

### SUMMARY OF THE INVENTION

The present invention is contrived to overcome the conventional disadvantages. Accordingly, an objective of the present invention is to provide a coin-free retail business management system and method that allows a coin-free transaction and a coin saving benefit to the customers of small businesses while reserving advantages for both the customers and the small businesses.

Here, customers relieve carriage burden of unwelcome coins from petty transactions, for example, buying a cup of coffee from frequent visiting coffee venders. Whereas the retail small business provides to the customer a chance of saving petty money or change from the current or previous transactions by keeping the transaction fraction in the system record and reimbursing it for the subsequent transaction of the customer.

Another objective is to enable the retail venders to reserve promotional sales ideas by adjusting petty change from a transaction fraction to the customer's favor in case certain present requirements are met like coming to the vender five times within a given period.

A further objective is to decrease petty change here and there, and to serve to minimize deferral budget by decreasing frequencies of coin mint and for the small business customers to save fee charges from coin collecting machines.

A still further objective is to enable the customers to frequent the small businesses by providing a coin cashing advantage to the customers using a charge-free coin machine that is linked to the business management system.

To achieve these and other objectives, the coin-free retail business management method according to the present invention comprises the steps of reading a customer identification into a business management system; retrieving a first value previously saved under the customer identification; comparing the first value to a second value from a present transaction amount, wherein the second value is a non-billable fraction from the present transaction amount, which is less than the face value of a lowest-valued monetary bill; generating a third value, wherein the third value is an addition of the first and second; and subtracting the addition less a non-billable fraction of the addition from the present traction amount.

In an embodiment, the method further comprises the step of increasing the third value to the face value of the lowest-valued monetary bill when a retail customer under the customer identification meets one or more predetermined requirements of the retail business. The method of claim 1 further comprising the step of replacing the third value with the first value.

The method is implemented in such that the customer identification is previously saved in the business management system operable by a predetermined software. Alternately, the customer identification may be a numerical ID free from personal information or one selected from a club card, a credit card, a driver license, a student ID, and a cellular phone.

To better realize the objectives, the method further comprises, prior to the reading of the customer identification, the step of customer inputting an alphanumerical ID. Selectively, the method may further comprise, prior to the reading of the customer identification, the step of customer voicing a random sound.

An another embodiment discloses a coin-free retail business management system having a processor comprising: a reader to recognize a customer identification into the system; a comparator to retrieve a first value previously saved under the customer identification and compare the first value to a second value from a present transaction amount, wherein the first value is less than the face value of a lowest-valued monetary bill, wherein the second value is a non-billable fraction from the present transaction amount, which is less than the face value of the lowest-valued monetary bill; an analyzer to derive a third value, wherein the third value is either an addition of the first and second values if the addition is less than the face value of the lowest-valued monetary bill, or a non-billable fraction of the addition if not; and a promoter to increase the third value to the face value of the lowest-valued monetary bill when a retail customer under the customer identification meets one or more predetermined requirements of the retail business.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a flowchart illustrating a coin-free retail business management method according to an embodiment of the present invention; and

FIG. 2 is a block diagram illustrating a coin-free retail business management system according to another embodiment of the present invention.

### DETAILED DESCRIPTION OF THE PREFERRED EMBODIMENTS

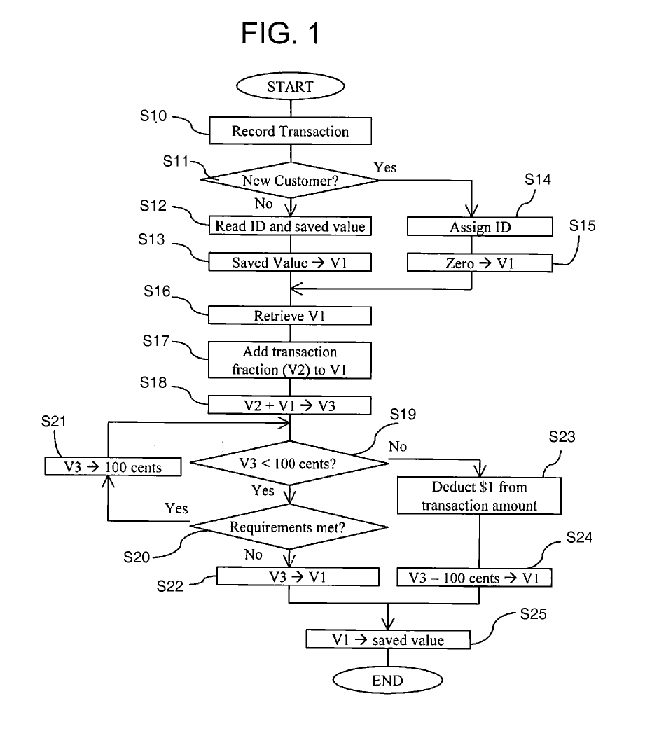

The flowchart in FIG. 1 illustrates the steps required for implementing the coin-free retail business management method. As shown therein, the overview of the method comprises the first step of reading a customer identification into a business management system. The second step comprises retrieving a first value previously saved under the customer identification. The third step comprises comparing the first value to a second value from a present transaction amount, where the second value is a non-billable fraction from the present transaction amount, which is less than the face value of the lowest-valued monetary bill. The fourth step comprises generating a third value, where the third value is an addition of the first and second values. The fifth step comprises subtracting the addition less a non-billable fraction of the addition from the present transaction amount.

For a better performance, the addition may be less than the face value of the lowest-valued monetary bill. Selectively, the first value can be an amount of coins deposited into the business management system via a coin cashing device by the customer who makes the present transaction.

In an embodiment, the method further comprises the step of increasing the third value to the face value of the lowest-valued monetary bill when a retail customer under the customer identification meets one or more predetermined requirements of the retail business.

In a preferred version, the method further comprises, after the fourth step, the step of replacing the third value with the first value. Here, the customer identification may be previously saved in the business management system which is operable by a predetermined software, or be a numerical ID free from personal information. Selectively, the customer identification may be one selected from a club card, a credit card, a driver license, a student ID, and a cellular phone.

To secure a desired implementation of the embodiment, the method further comprises, prior to the reading of the customer identification, the step of customer inputting an alphanumerical ID. Alternately, the method may further comprise, prior to the reading of the customer identification, the step of customer voicing a random sound.

In a preferred mode, the method further comprises, after the subtracting step, increasing the non-billable fraction of the addition to the face value of the lowest-valued monetary bill when a retail customer under the customer identification meets one or more predetermined requirements of the retail business.

Following the overview above, the detailed steps of the method will now be explained with an exemplary transaction in a street corner coffee store. When a customer walks in the store a cup of coffee, the transaction will be recorded in form of the seller issuing a transaction receipt (S10). At this point, the seller will inquire if the customer is new to the store (S11). Such patronage status may be determined by voice activation system or by an alphanumerical identification input of the customer. So if the customer's such data is previously recorded in the retail business management system, then the recorded ID and the previously saved value will be read (S12). Here, the saved value means one previously saved under the customer ID and the saved value is less than the face value of a lowest-valued monetary bill. Namely, the saved value will be non-billable and coinable-only value less than 100 cents when dealt with under a dollar system. Thereafter, the saved value will be set as the first value V1 (S13).

At S11 for deciding patronage status, if the customer is new to the store, a new ID will be assigned (S14) and value zero will be set to the first value V1 (S15). Then, the first value V1 will be retrieved (S16). Subsequently, the transaction fraction or non-billable petty change from the transaction or the second value V2 will be added to the first value V1 (S17). The added value of the fraction V2 and the first value V1 will be set as a third value V3 (S18).

In the subsequent inquiry step (S19), if the third value is less than the face value of the lowest-valued monetary bill or less than 100 cents in a dollar system then additional question may be inquired to see if any present promotional requirements are met (S20) in the transaction history of the customer. If the requirements are met then the seller may increase the third value V3 to the lowest-valued monetary bill or one dollar in a dollar system (S21) and the increase value of V3 will be reviewed one more time at the inquiry step S19.

Meanwhile, if the inquiry step S19 results in the third value being equal or more than the face value of the lowest-valued monetary bill or one dollar in a dollar system then the seller may deduct from the traction amount the face value of the lowest-valued monetary bill or one dollar in a dollar system (S23). The resultant value will then be set to the first value V1 (S24) which then will be set to the saved value (S25). Also, in the inquiry step S20, if the requirements are not met then the third value will be set to the first value (S22) and then the first value V1 will be the saved value (S25).

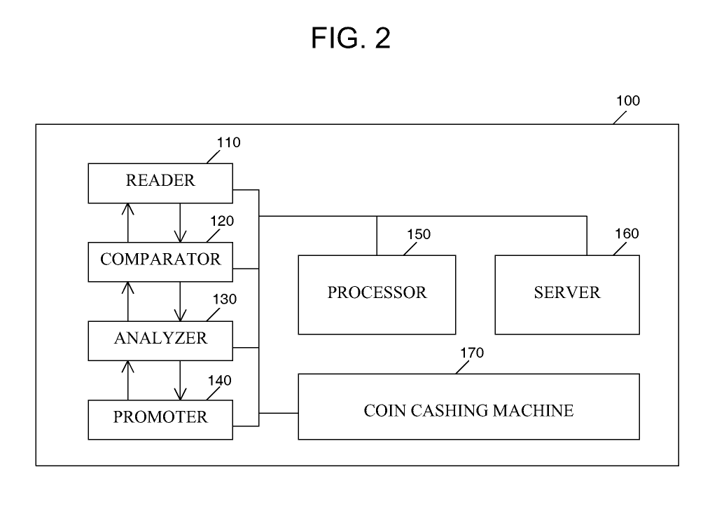

With reference to FIG. 2, the coin-free retail business management system 100 having a processor 150 comprises a reader 110 to recognize a customer identification into the system 100. Here, the processor 150 cooperates with a server 160 when operating under a network such as WAN and LAN. Selectively provided under this construction is a coin cashing device 170 for enabling small business customers to cash coins so that the cashed amount can be reflected to the purchase without charge for coin cashing. Preferably, the coin cashing device 170 is provided near the small business store whose network is linked to the coin cashing device 170. Meanwhile, the customer identification may be either saved from a previous transaction or currently received from an instant transaction. The system 100 is a computer-implemented system operating based on one or more preset software programs. A comparator 120 is provided to retrieve a first value previously saved under the customer identification and compare the first value to a second value from a present transaction amount.

Here, the first value is less than the face value or one hundred cents of a lowest-valued monetary bill or one dollar. The second value is a non-billable fraction or petty change from the present transaction amount, which is less than the face value of the lowest-valued monetary bill.

An analyzer 130 serves to derive a third value which is either an addition of the first and second values if the addition is less than the face value of the lowest-valued monetary bill, or a non-billable fraction of the addition if not. In a preferred mode, a promoter 140 serves to increase the third value to the face value of the lowest-valued monetary bill when a retail customer under the customer identification meets one or more predetermined requirements of the retail business.

To further improve the system utility a coin cashing device 170 may be linked to the business management system 100, wherein the first value is an amount of coins deposited into the business management system via a coin cashing device by the retail customer making the present transaction.

Preferably, the reader 110 of the system 100 is a voice-activated apparatus integrated to the system, or cooperates with one or more selected from a club card, a credit card, a driver license, a student ID, and a cellular phone. Also, the customer identification is previously saved in the business management system operable by a predetermined software. Selectively, the customer identification may be either a numerical ID free from personal information or an alphanumerical ID free from personal information.

As discussed above, an advantage of the present invention enables the customers to perform a coin-free transaction with small businesses while reserving advantages for both the customers and the small businesses. For example, customers relieve carriage burden of unwelcome coins from petty transactions when buying a cup of coffee from frequent visiting coffee venders. Whereas the retail small business provides to the customer a chance of saving petty money or change from the current or previous transactions by keeping the transaction fraction in the system record and reimbursing it for the subsequent transaction of the customer.

Further, the system and method according to the present invention enables the retail venders to reserve promotional sales ideas by adjusting petty change from a transaction fraction to the customer's favor in case certain present requirements are met like coming to the vender five times within a given period. In addition, the system and method serves to decrease petty change here and there, and to serve to minimize deferral budget by decreasing frequencies of coin mint and for the small business customers to save fee charges from coin collecting machines. Moreover, the system leads the customers to frequent the small businesses by providing a coin cashing advantage to the customers using a charge-free coin machine that is linked to the business management system.

Although the invention has been described in considerable detail with reference to certain preferred versions thereof, other versions are possible by converting the aforementioned construction. Therefore, the scope of the invention shall not be limited by the specification specified above and the appended claims.

What is claimed is:

1. A coin-free retail business management method, comprising the steps of:
reading a customer identification into a business management system;
retrieving a first value previously saved under the customer identification;
comparing the first value to a second value from a present transaction amount, wherein the second value is a non-billable fraction from the present transaction amount, which is less than the face value of a lowest-valued monetary bill;
generating a third value, wherein the third value is an addition of the first and second values; and
subtracting the addition less a non-billable fraction of the addition from the present transaction amount.

2. The method of claim 1 wherein the first value is less than the face value of the lowest-valued monetary bill.

3. The method of claim 1 wherein the first value is an amount of coins deposited into the business management system via a coin cashing device by the customer making the present transaction.

4. The method of claim 1 further comprising, after the subtracting step, the step of replacing the third value with the first value.

5. The method of claim 1 wherein the customer identification is previously saved in the business management system operable by a predetermined software.

6. The method of claim 1 wherein the customer identification is a numerical ID free from personal information.

7. The method of claim 1 wherein the customer identification is one selected from a club card, a credit card, a driver license, a student ID, and a cellular phone.

8. The method of claim 1 further comprising, prior to the reading of the customer identification, the step of customer inputting an alphanumerical ID.

9. The method of claim 1 further comprising, prior to the reading of the customer identification, the step of customer voicing a random sound.

10. A coin-free retail business management method, comprising the steps of:
reading a customer identification into a business management system;
retrieving a first value previously saved under the customer identification;
comparing the first value to a second value from a present transaction amount, wherein the second value is a non-billable fraction from the present transaction amount, which is less than the face value of a lowest-valued monetary bill, generating a third value, wherein the third value is an addition of the first and second values;
subtracting the addition less a non-billable fraction of the addition from the present transaction amount; and
increasing the non-billable fraction of the addition to the face value of the lowest-valued monetary bill when a retail customer under the customer identification meets one or more predetermined requirements of the retail business.

11. The method of claim 10 wherein the first value is less than the face value of the lowest-valued monetary bill.

12. The method of claim 10 wherein the first value is an amount of coins deposited into the business management system via a coin cashing device by the retail customer making the present transaction.

13. The method of claim 10 further comprising the step of replacing the third value with the first value.

14. The method of claim 10 wherein the customer identification is previously saved in the business management system operable by a predetermined software.

15. The method of claim 10 wherein the customer identification is a numerical ID free from personal information.

16. The method of claim 10 wherein the customer identification is one selected from a club card, a credit card, a driver license, a student ID, and a cellular phone.

17. The method of claim 10 further comprising, prior to the reading of the customer identification, the step of customer inputting an alphanumerical ID.

18. The method of claim 10 further comprising, prior to the reading of the customer identification, the step of customer voicing a random sound.

19. A coin-free retail business management system having a processor, comprising:
a reader to recognize a customer identification into the system;
a comparator to retrieve a first value previously saved under the customer identification and compare the first value to a second value from a present transaction amount, wherein the second value is a non-billable fraction from the present transaction amount, which is less than the face value of a lowest-valued monetary bill;
an analyzer to derive a third value, wherein the third value is an addition of the first and second values; and
a promoter to increase the third value to the face value of the lowest-valued monetary bill when a retail customer under the customer identification meets one or more predetermined requirements of the retail business.

20. The method of claim 19 wherein the first value is less than the face value of the lowest-valued monetary bill.

21. The system of claim 19 further comprising a coin cashing device linked to the business management system, wherein the first value is an amount of coins deposited into the business management system via a coin cashing device by the retail customer making the present transaction.

22. The system of claim 19 wherein the reader is a voice-activated apparatus integrated to the system.

23. The system of claim 19 wherein the reader cooperates with one or more selected from a club card, a credit card, a driver license, a student ID, and a cellular phone.

24. The system of claim 19 wherein the customer identification is previously saved in the business management system operable by a predetermined software.

25. The system of claim 19 wherein the customer identification is a numerical ID free from personal information.

26. The system of claim 19 wherein the customer identification is an alphanumerical ID free from personal information.
